(19) United States
(12) Patent Application Publication
(10) Pub. No.: US 2022/0270193 A1
(43) Pub. Date: Aug. 25, 2022

(54) METHOD FOR PUBLIC UTILIZATION OF HOUSING

(71) Applicant: Chul Ho WON, Wonju-si, Gangwon-do (KR)

(72) Inventor: Chul Ho WON, Wonju-si, Gangwon-do (KR)

(21) Appl. No.: 17/633,582

(22) PCT Filed: Aug. 6, 2020
(86) PCT No.: PCT/KR2020/010397

§ 371 Date: Feb. 8, 2022

(30) Foreign Application Priority Data
Aug. 10, 2019 (KR) 10-2019-0097880

(51) Int. Cl. G06Q 50/26; G06Q 30/06; G06Q 50/16; G06Q 30/02; G06Q 20/14

(52) U.S. Cl. CPC G06Q 50/26; G06Q 30/0623; G06Q 50/163; G06Q 30/0206; G06Q 20/14

(57) ABSTRACT

The present invention relates to a method for the public utilization of housing, including the steps of: establishing a housing utilization platform wherein a housing utilization platform operated and managed by the utilization housing supplier is opened; disclosing and browsing utilized houses on the established housing utilization platform, allowing the utilization housing supplier to disclose the utilized house and the utilization housing consumer who signed up for membership to browse the disclosed utilized house; and signing a housing utilization contract, based on the results of browsing the utilized house, to conclude a housing utilization contract between a utilization housing supplier and a plurality of utilization housing consumers, respectively, thereby creating stable profit for the housing supplier and proving residential stability and the convenience of free housing relocation for the housing consumer.

### TECHNICAL FIELD

The present invention relates to a method for the public utilization of housing, and more particularly to a method for the public utilization of housing that introduces a new housing utilization right instead of the existing ownership-based residential form to create stable profit for the housing supplier and provide residential stability and convenience of free housing relocation for the housing consumer.

### BACKGROUND ART

Housing is an essential field for people to survive and is a very important element that occupies the largest portion of the economy of individual family communities. Therefore, it has been managed as a key issue not only in each household but also in the country.

As a representative method of the current housing transaction method, a housing transaction and residence method through sale between parties as in Korean Laid-open Patent Publication No. 2013-0007406, “Real Estate Trade System and Operating Method Thereof’, and a housing transaction and residence method using auctions as in Korean Laid-open Patent Publication No. 2016-0125819, “Auction method through internet and system thereof”, are mainly used.

However, in the housing transaction and residence method as described above, housing suppliers are always concerned about unsold housing, and housing consumers can experience enormous damage to the home economy when housing prices fall, making it difficult to relocate housing. The country faces problems in that the gap between the rich and poor caused by severe income inequality occurred due to the unearned income from housing when housing prices rise, and the household economy collapsed when housing prices fell.

Accordingly, a housing supply and consumption system is needed to enable enough housing supply for housing suppliers, an easy residence relocation for housing consumers, and fundamental solutions of a sensitive housing supply and management field in terms of national policy for the country.

### DISCLOSURE

### Technical Problem

In order to solve the above problems, it is an object of the present invention to provide a method for the public utilization of housing that establishes a housing utilization platform operated and managed by the utilization housing supplier, discloses utilized houses of the utilization housing supplier in the established housing utilization platform, and allows the member registered to browse the disclosed utilized house.

In addition, it is another object of the present invention to provide a method for the public utilization of housing in which a utilization housing supplier and each of multiple utilization housing consumers sign a housing utilization contract after browsing the disclosed utilized house, and when the basic residence fee and additional residence fee are deposited according to the housing utilization contract, multiple utilization housing consumers may reside and move to each utilized house.

In addition, it is still another object of the present invention to provide a method for the public utilization of housing that the remaining residence fee accrued when multiple utilization housing consumers reside in and move to each utilized house is refunded to the previous utilization housing consumers who previously resided in and moved to the same utilized house by utilization housing supplier.

### Technical Solution

In order to achieve the above objects, a method for the public utilization of housing according to the present invention includes: establishing a housing utilization platform operated and managed by the utilization housing supplier; disclosing and browsing the utilized house, which allow the utilization housing supplier to disclose the utilized house on the established housing utilization platform and the utilization housing consumer who registered as a member to browse the disclosed utilized house; concluding a housing utilization contract between the utilization housing supplier and multiple utilization housing consumers after browsing the utilized house; residing in and moving to each utilized house, which allow multiple utilization housing consumers to reside in and move to each utilized house when the basic residence fee and additional residence fee are deposited according to each of concluded housing utilization contracts; and refunding the remaining residence fee accrued when multiple utilization housing consumers reside in and move to each utilized house to the previous utilization housing consumer who previously resided in and moved to the same utilized house by the utilization housing supplier.

In addition, a basic residence fee is the basic residence amount that must be paid for living in the utilized housing, which is set by the utilization housing supplier considering the average standard market price of new homes with the same area, while multiple amounts are set for each area, and is cumulatively depreciated every day in the same amount as the standard market price of each utilized house in which the housing consumer resides, which is characterized in that, when the utilization housing consumers apply refund of the remaining housing fee remaining after depreciation by residence from the basic residence fee paid in the housing utilization platform after canceling the residential contract of the utilized house, the remaining residence fee is deposited to a designated deposit and withdrawal account of the utilization housing consumer entered for membership registration, and the utilization housing consumer is notified of the detail of deposit and refund through a terminal while the detail is disclosed on the housing utilization platform.

In addition, an additional residence fee is accrued from the gap between the standard market price of the utilized house in which the utilization housing consumer wishes to reside and the remaining residence fee of the utilization housing consumer applied to the utilized house that the utilization housing consumer wishes to reside when the standard market price of the utilized house exceeds the value of the remaining residence fee, and is an amount that the utilization housing consumer who wishes to reside needs to deposit by adding a deficit to be the same amount as the standard market price of the utilized house to a deposit and withdrawal account of the utilization housing supplier entered for membership registration of the housing utilization platform, which is characterized in that the utilization housing consumer is notified of the detail of deposit through a terminal while the detail is disclosed on the housing utilization platform.

In addition, a remaining residence fee is an amount left after accumulating depreciation on a daily basis by the residence of the utilized house from the basic residence fee paid at the beginning of residence in utilized house, and the balance of the same day of the basic residence fee or the balance of the same day after accumulating depreciation on a daily basis for the residence period of the utilized house after moving in, from the sum of remaining residence fee which is the balance of the same day of basic residence fee and the additional residence fee for moving in, which is characterized in that, if the amount of remaining residence fee of the utilization housing consumer who wishes to move to the utilized house exceeds the standard market price of the utilized house where the utilization housing consumer wishes to reside, the utilization housing consumer who wishes to move in applies refund of remaining residence amount on the housing utilization platform for the difference between the remaining residence fee of the utilization housing consumer and the standard market price of the utilized house where the consumer wishes to reside; refund of some remaining residence fee amounting to the difference is completed by the utilization housing supplier depositing the money to a designated deposit and withdrawal account of the utilization housing consumer, who wishes to move in, entered for membership registration of the housing utilization platform; after the utilization housing consumer cancels the residence contract of the utilized house where the consumer resides, the utilization housing consumer who canceled the residence contract applies refund of remaining residence fee on the housing utilization platform, the refund of the total remaining residence fee is completed by the utilization housing supplier depositing the money to a designated deposit and withdrawal account of the utilization housing consumer, who canceled the residence contract, entered for membership registration of the housing utilization platform; and the utilization housing consumer is notified of the detail of refund of remaining residence fee through a terminal while the detail is also disclosed on the housing utilization platform.

In addition, an established housing utilization platform is characterized by displaying at least one of membership registration information of the utilization housing consumer, disclosure of habitable utilized house by the utilization housing supplier, disclosure of utilized house to be moved by the utilization housing supplier, disclosure of utilized house applied for movement by the utilization housing consumer, browser of utilized house for residential use by the utilization housing consumer, disclosure of the standard market price of utilized house by the utilization housing supplier, confirmation of the standard market price of utilized house by the utilization housing consumer, conclusion of a housing utilization contract between the utilization housing supplier and the utilization housing consumer, registration of a deposit and withdrawal account designated by the utilization housing supplier, registration of each deposit and withdrawal account designated by each of the utilization housing consumers, payment details of basic residence fee by utilization housing consumer, notification of the basic residence fee payment by the utilization housing supplier, disclosure of the basic residence fee payment results by the utilization housing supplier, application for allocation of utilized house by the utilization housing consumer, disclosure of allocation application results of utilized house by utilization housing consumers, application for exchange of utilized houses by the utilization housing consumer, disclosure of exchange application results of utilized houses by the utilization housing suppliers, payment of additional residence fee by utilization housing consumers, notification of additional residence fee payment details by utilization housing supplier, disclosure of additional residence fee payment results by the utilization housing supplier, disclosure of remaining residence fee by the utilization housing supplier, confirmation of remaining residence fee by the utilization housing consumer, application for refund of remaining residence fee by the utilization housing consumer, refund of remaining residence fee by the utilization housing supplier, notification of refund results of remaining residence fee by the utilization housing supplier, disclosure of refund results of remaining residence fee by the utilization housing supplier, application for defect repair by the utilization housing consumer, and disclosure of defect repair results by the utilization housing supplier.

In addition, at the step of disclosing and browsing the utilized house, as an evaluation method of the standard market price for the disclosure of the utilized house, \textcircled{1} Standard market price of utilized house=amount per m²×area of the building to be evaluated (m²) \textcircled{2} Amount per m²=standard amount of new building price×structural index×location index×residual portion rate per elapsed year are applied, wherein the structural index is applied by dividing into 10 levels according to the degree of convenience; the location index is applied by dividing into 20 levels from large cities to rural areas; the depreciation rate per elapsed year is applied as 1 year (new construction): 100%, 1 to 10 years: 35%, 10 to 20 years: 25%, 20 to 30 years: 20%, 30 to 40 years: 10%, and 40 to 50 years: 10%, the detailed residual portion rate and depreciation rate are applied as 1 to 2 years: 96% (depreciation rate of 4%), 2 to 3 years: 92% (depreciation rate of 4%), 3 to 4 years: 88% (depreciation rate of 4%), 4 to 5 years: 82% (depreciation rate of 4%), 5 to 6 years: 78% (depreciation rate of 4%), 6 to 7 years: 74% (depreciation rate of 4%), 7 to 8 years: 71% (depreciation rate of 3%), 8 to 9 years: 68% (depreciation rate of 3%), 9 to 10 years: 65% (depreciation rate of 3%), 10 to 11 years: 62% (depreciation rate of 3%), 11 to 12 years: 59% (depreciation rate of 3%), 12 to 13 years: 56% (depreciation rate of 3%), 13 to years: 53% (depreciation rate of 3%), 14 to 15 years: 50% (depreciation rate of 3%), 15 to 16 years: 48% (depreciation rate of 2%), 2016 to 17: 46% (depreciation rate of 2%), 17 to 18 years: 44% (depreciation rate of 2%), 18 to 19 years: 42% (depreciation rate of 2%), 19 to 20 years: 40% (depreciation rate of 2%), 20 to 30 years: 40% (annual depreciation rate of 1.5%), and among 30 to 50 years, 30 to 35 years: 25% (annual depreciation rate of 1.5%) and 36 to 50 years: 25% (annual depreciation rate of 1%). However, the depreciation rate and residual portion rate set from 1 to 50 years are adjusted by the utilization housing supplier; as the standard market price evaluation criteria for the utilized house when purchasing, \textcircled{1} Standard market price of utilized house=amount per m²×area of the building to be evaluated (m²) \textcircled{2} Amount per m²=standard amount of new building price×structural index×location index×residual portion rate by elapsed years are applied as an evaluation criteria for the newly constructed utilized house, wherein the structural index is applied by dividing into 10 levels according to the degree of convenience; and the location index is divided into 20 levels from large cities to rural areas according to the official land price and housing convenience, and if the individual housing deterioration degree of the utilized house is added in 10 levels and reflected, it is set by the utilization housing supplier.

In addition, the housing utilization contract is characterized by including, at the step of signing the housing utilization contract, at least one of information on the contracting parties, contract date and time, signatures by the contracting parties, and the basic contract provisions necessary for using the housing utilization platform; a provision requiring the utilization housing consumer who wishes to reside in the utilized house to deposit the basic residence fee into the deposit account designated by the utilization housing supplier when the housing utilization contract is concluded; and a provision requiring the utilization housing consumer who wishes to reside in the utilized house to deposit additional residence fee before moving to a utilized house if the standard market price of the utilized house desired to reside exceeds the amount of remaining residence fee of the housing utilization consumer who wishes to reside.

### Advantageous Effects

A method for the public utilization of housing according to the present invention to achieve the above objects enables a point at which the residential utility of built or purchased house is lost to be set after construction or purchase of a house by breaking away from the generally accepted housing transaction method in which houses are sold or rented, and then, the balance remaining after depreciation of the housing price on a daily basis according to the number of days of residence to be refunded whenever it is needed, thereby excluding ownership completely.

In addition, there is an effect of guaranteeing freedom to reside in a desired location and environment, easy housing relocation, and quick refund difficult to solve in the current housing sale and rental system.

Accordingly, the convenience of living in housing for foreigners is greatly improved, thereby allowing active exchanges between citizens of each country when utilized houses are built in countries around the world.

And if the state or public corporation in charge of housing construction utilizes the present invention, it can help to balance the national development by alleviating the phenomenon of concentration in the metropolitan area, and prevent house speculation because the rise in housing prices is fundamentally impossible, thereby resolving a significant part of the national difficulties caused by the housing sector.

### DESCRIPTION OF DRAWINGS

FIG. 1 is an internal step diagram of a housing utilization platform applied to the present invention.

FIG. 2 is a step diagram of a method for the public utilization of housing according to the present invention.

FIG. 3 is an internal utilization diagram of a method for the public utilization of housing according to the present invention.

### BEST MODE

Hereinafter, the present invention will be described in more detail.

Preferred embodiments of the present invention will be described in detail with reference to the accompanying drawings. Terms or words used in the present specification and the claims described below prior to the detailed description of the present invention are not to be interpreted limitedly to common or dictionary meanings. Therefore, since the embodiments described in the present specification and the configuration shown in the drawings are only a most preferred embodiment of the present invention and do not represent all the technical ideas of the present invention, it should be understood that various modifications and equivalents may be substituted for them at the time of filing the present application.

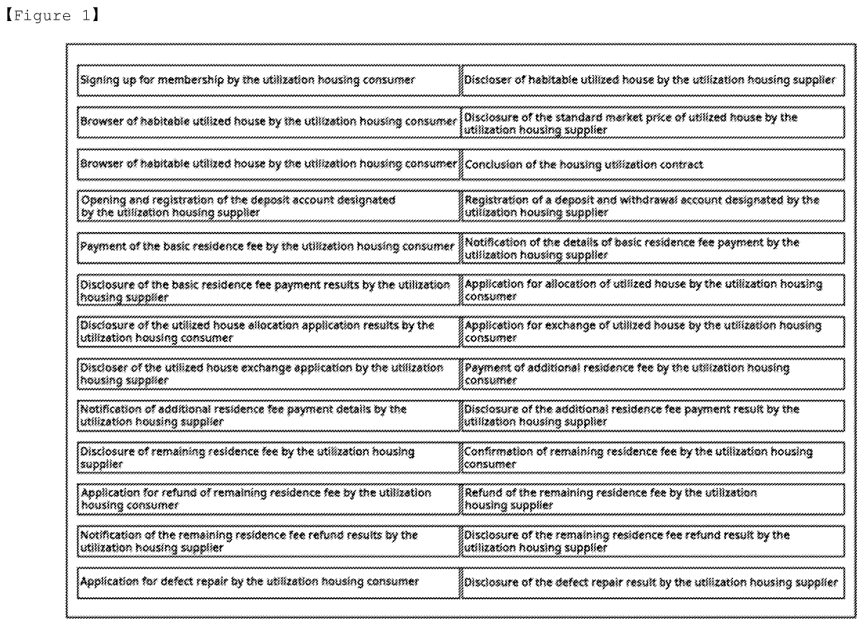

FIG. 1 is an internal step diagram of a housing utilization platform applied to the present invention.

A utilization housing in the present invention is to solve the shortcomings of housing residence and relocation using sale and rental based on ownership currently in general use.

A utilized house allows easy relocation, removes concerns about housing management, allows immediate refund of residence fee, and allows continuous residence in the utilized house even after housing utilization period ends at the ends of house lifespan, thereby being helpful for the economic life of the common people. A utilization housing means a housing supplied by a new housing supply method based on the right to utilize housing that has a value comparable to the ownership of the house, rather than based on the ownership of a housing.

The participating entities involved in a method of the public utilization of housing in the present invention are composed of a utilization housing supplier and a utilization housing consumer.

As a utilization housing supplier, all including the state, organizations, companies, and individuals may participate as subjects, and are responsible for the establishment, operation, and management.

In addition, a utilization housing supplier is also responsible for securing the utilized house connected to the housing utilization platform and managing all the houses.

In addition, in the established housing utilization platform, each of the multiple utilization housing consumers may register for free membership, and a utilization housing supplier and each of the multiple utilization housing consumers may sign up a utilization housing contract.

In addition, it is possible to operate and manage all matters related to a utilization housing supplier and utilization housing consumers that are required online for public utilization of housing.

Accordingly, as shown in FIG. 1, an established housing utilization platform allows all matters such as registration of membership by the utilization housing consumer, disclosure of habitable utilized house by the utilization housing supplier, disclosure of utilized house to be moved by the utilization housing supplier, disclosure of utilized house applied for movement by the utilization housing consumer, browser of utilized house for residential use by the utilization housing consumer, disclosure of the standard market price of utilized house by the utilization housing supplier, confirmation of the standard market price of utilized house by the utilization housing consumer, conclusion of a housing utilization contract between the utilization housing supplier and the utilization housing consumer, registration of a deposit and withdrawal account designated by the utilization housing supplier, registration of each deposit and withdrawal account designated by each of the utilization housing consumers, payment of basic residence fee by utilization housing consumer, notification of the basic residence fee payment details by the utilization housing supplier, disclosure of the payment result of basic residence fee by the utilization housing supplier, application for allocation of utilized house by the utilization housing consumer, disclosure of allocation application results of utilized house by the utilization housing consumer, application for exchange of utilized houses by the utilization housing consumer, disclosure of exchange application results by the utilization housing suppliers, payment of additional residence fee by the utilization housing consumer, notification of additional residence fee payment details by utilization housing supplier, disclosure of additional residence fee payment results by the utilization housing supplier, disclosure of remaining residence fee by the utilization housing supplier, confirmation of remaining residence fee by the utilization housing consumer, application for refund of remaining residence fee by the utilization housing consumer, refund of remaining residence fee by the utilization housing supplier, notification of refund results of remaining residence fee by the utilization housing supplier, disclosure of refund results of remaining residence fee by the utilization housing supplier, application for defect repair by the utilization housing consumer, and disclosure of defect repair results by the utilization housing supplier.

And a basic residence fee means, in respect of residence in a utilized house, a basic residence amount that must be paid for living in the utilized house, which is set by a utilization housing supplier considering the average standard market price of new homes with the same area constructed all over the country regardless of location and environment, while multiple amounts may be set for each area.

In addition, as each of the multiple utilization housing consumers resides in a utilized house, the amount is cumulatively depreciated every day in the same amount as the standard market price of each utilized house (3). When the utilization housing consumers apply for refund of the remaining housing fee left after depreciation by residence from the basic residence fee paid in the housing utilization platform after canceling the residence in the utilized house where the utilization housing consumer resides, the remaining residence fee is immediately deposited by the utilization housing supplier to a deposit and withdrawal account designated by the utilization housing consumer registered to the housing utilization platform, thereby allowing refund whenever it is needed.

And the utilization housing consumer is notified of the detail of deposit and refund through a terminal while the detail may be disclosed on the housing utilization platform.

In addition, an additional residence fee according to the present invention is accrued from the gap between the standard market price of the utilized house in which the utilization housing consumer wishes to reside and the remaining residence fee of the utilization housing consumer who applied to the utilized house that the utilization housing consumer wishes to reside when the standard market price of the utilized house exceeds the value of the remaining residence fee.

That is, an additional residence fee means an additional deposit amount that needs to be deposited adding the deficit so as to be the same amount as the standard market price of the utilized house by a utilization housing consumer to a deposit and withdrawal account designated by the utilization housing supplier opened in the housing utilization platform, and the utilization housing consumer is notified of the detail of deposit while the detail is disclosed on the housing utilization platform.

In addition, a remaining residence fee according to the present invention means the balance of the same day of the basic residence fee left after accumulating depreciation on a daily basis by the residence of the utilized house, without relocation, from the basic residence fee paid at the beginning of residence in utilized house, or simultaneously means the balance of the same day, left after accumulating depreciation on a daily basis for the residence period of the utilized house after moving in, from the sum of remaining residence fee which is the balance of the same day of basic residence fee and the additional residence fee for moving in.

And, in respect of relocation to a utilized house according to the present invention, if the amount of remaining residence fee of the utilization housing consumer who wishes to move in exceeds the standard market price of the utilized house where the utilization housing consumer wishes to reside, the utilization housing consumer who wishes to move in applies refund of remaining residence amount on the housing utilization platform for the difference between the remaining residence fee of the utilization housing consumer and the standard market price of the utilized house where the consumer wishes to reside, and refund of some remaining residence fee amounting to the difference is completed by the utilization housing supplier depositing the money to a deposit and withdrawal account designated by the utilization housing consumer registered to the housing utilization platform.

In addition, after the utilization housing consumer cancels the residence of the utilized house where the consumer resides, the utilization housing consumer who canceled the residence applies refund of remaining residence fee on the housing utilization platform, and the refund of the total remaining residence fee is completed by the utilization housing supplier depositing the money to a deposit and withdrawal account designated by the utilization housing consumer registered to the housing utilization platform.

In this case, the utilization housing consumer is notified of the detail of refund of remaining residence fee while the detail is disclosed on the housing utilization platform.

In addition, as an evaluation method of the standard market price for the disclosure of the utilized house,

as an evaluation method of the standard market price for the disclosure of the utilized house,

\textcircled{1} Standard market price of utilized house=amount per m²×area of a building to be evaluated (m²), and

\textcircled{2} Amount per m²=standard amount of new building price×structural index×location index×residual portion rate per elapsed year are applied,

wherein the structural index is applied by dividing into 10 levels according to the degree of convenience;

the location index is applied by dividing into 20 steps from large cities to rural areas;

the depreciation rate per elapsed year is applied as 1 year (new construction): 100%, 1 to 10 years: 35%, 10 to 20 years: 25%, 20 to 30 years: 20%, 30 to 40 years: 10%, and 40 to 50 years: 10%,

the detailed residual portion rate and depreciation rate are applied as

1 to 2 years: 96% (depreciation rate of 4%), 2 to 3 years: 92% (depreciation rate of 4%), 3 to 4 years: 88% (depreciation rate of 4%), 4 to 5 years: 82% (depreciation rate of 4%), 5 to 6 years: 78% (depreciation rate of 4%), 6 to 7 years: 74% (depreciation rate of 4%), 7 to 8 years: 71% (depreciation rate of 3%), 8 to 9 years: 68% (depreciation rate of 3%), 9 to 10 years: 65% (depreciation rate of 3%), 10 to 11 years: 62% (depreciation rate of 3%), 11 to 12 years: 59% (depreciation rate of 3%), 12 to 13 years: 56% (depreciation rate of 3%), 13 to 14 years: 53% (depreciation rate of 3%), 14 to 15 years: 50% (depreciation rate of 3%), 15 to 16 years: 48% (depreciation rate of 2%), 2016 to 17: 46% (depreciation rate of 2%), 17 to 18 years: 44% (depreciation rate of 2%), 18 to 19 years: 42% (depreciation rate of 2%), 19 to 20 years: 40% (depreciation rate of 2%), 20 to 30 years: 40% (annual depreciation rate of 1.5%) residual portion rate, residual portion rate, and among 30 to 50 years, 30 to 35 years: 25% (annual depreciation rate of 1.5%) and 36 to 50 years: 25% (annual depreciation rate of 1%), but the depreciation rate and residual portion rate set from 1 to 50 years are adjusted by the utilization housing supplier.

As the standard market price evaluation criteria for the utilized house at the time of purchase,

\textcircled{1} Standard market price of utilized house=amount per m²×area of the building to be evaluated (m₂) and

\textcircled{2} Amount per m²=standard amount of new building price×structural index×location index×residual portion rate per elapsed years are applied as an evaluation criteria for the newly constructed utilized house,

wherein the structural index is applied by dividing into 10 levels according to the degree of convenience;

and the location index is applied by dividing into 20 levels from large cities to rural areas according to the official land price and housing convenience, and

if the individual housing deterioration degree of the utilized house is added in 10 levels and reflected, it is set by the utilization housing supplier.

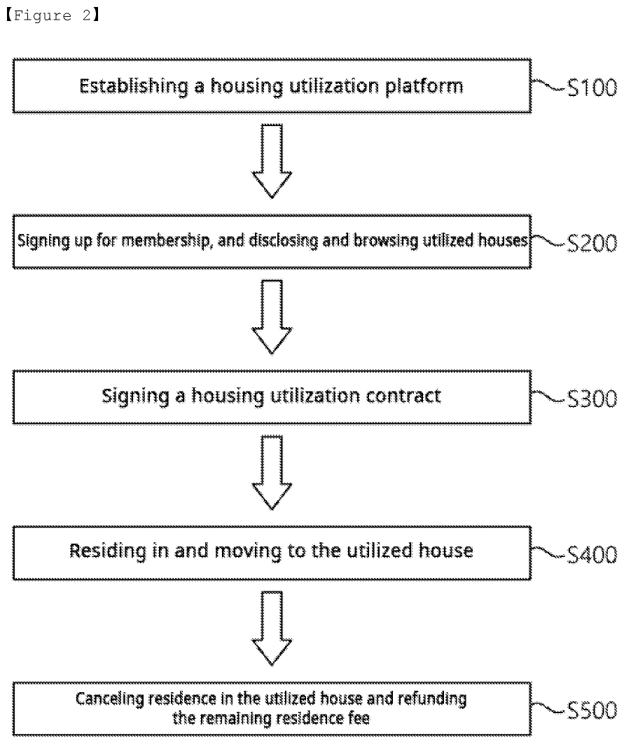

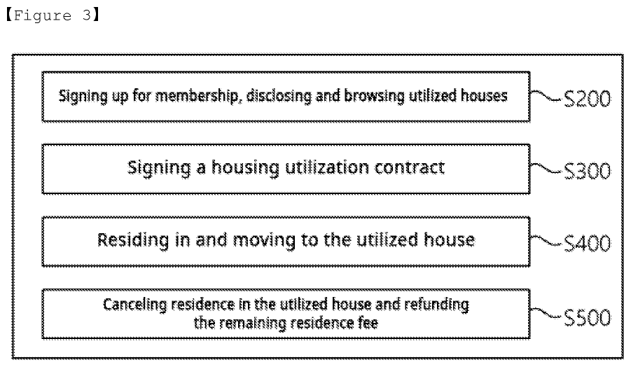

FIG. 2 is a step diagram of a method for the public utilization of housing according to the present invention, and FIG. 3 is an internal utilization diagram of a method for the public utilization of housing according to the present invention.

Referring to FIG. 2 and FIG. 3, a method for the public utilization of housing includes the steps of: establishing a housing utilization platform (S100) wherein a housing utilization platform is established, operated, and managed by the utilization housing supplier; disclosing and browsing utilized houses on the established housing utilization platform (S200), allowing the utilization housing supplier to disclose the utilized house and the utilization housing consumer who signed up for membership to browse the disclosed utilized house; signing a housing utilization contract (S300), based on the results of browsing the utilized house, to conclude a housing utilization contract between a utilization housing supplier and multiple utilization housing consumers, respectively; residing and moving to the utilized house (S400), wherein each of multiple utilization housing consumers may reside in and move to the utilized house by depositing a basic residence fee and an additional residence fee based on the housing utilization contract; and canceling the residential contract of the utilized house and refunding a remaining residence fee (S500), wherein the utilization housing supplier returns the remaining residence fee accrued when the utilization housing consumer reside in and move to each utilized house to the utilization housing consumer who resided in each utilized house.

At the step of disclosing and browsing utilized houses (S200), in the case of utilization housing that is planned to be constructed, it is mandatory to complete the construction of the utilized house before a move-in date, so that actual occupancy is made possible on the move-in date according to the housing utilization contract (5).

And it is possible to purchase houses located across the country, immediately after appraisal, at the standard market price. When a house seller vacates a house, it is possible to pay a purchase money immediately through a purchase money payment method, and the purchased house is converted into a utilized house, thereby being managed so that it is possible to reside immediately by the choice of a waiting utilization housing consumer.

Alternatively, if a house seller wishes to continue residing in a house in which the house seller currently resides or to relocate residence, a housing utilization contract is signed between the house seller and the utilization housing supplier, a remaining residence fee which is the same amount as the purchase price of the house is deposited into a deposit and withdrawal account designated by the utilization housing supplier, an ownership of the house is transferred to the utilization housing supplier, and the details of the deposit are notified to the house seller and disclosed simultaneously on the housing utilization platform.

Accordingly, after registering on the housing utilization platform of the designated deposit and withdrawal account, the house seller of the house will be able to utilize all matters related to the public utilization of the house and related to the residence and relocation of the utilized house.

In addition, for the disclosure of the utilized house inhabited by the utilization housing consumer for a housing relocation, it is possible to disclose by registration of the utilization housing consumer living in the utilized house in a designated part of the housing utilization platform established by the utilization housing supplier and also disclose by the utilization housing supplier upon the application of the utilization housing consumer residing in the utilized house.

Therefore, the utilization housing supplier may disclose all the habitable utilized houses by adding the purchased utilized house to the utilization house to be built.

And at the step of signing a housing utilization contract (S300), when a utilization housing supplier and multiple utilization housing consumers sign up a housing utilization contract, respectively, the contents of the housing utilization contract include the basic provisions of the contract, such as information on the contracting parties, contract date and time, signatures of the contracting parties, which are necessarily required for using the housing utilization platform.

And it is possible to include multiple basic provisions related to the public utilization of housing. As the contents of multiple basic provisions, a provision stating that it is based on the right to utilize a house instead of an ownership of a house that is currently generally used in housing transactions, is included, and it is stipulated that the utilized house is a means of housing residence.

In addition, a provision requiring the utilization housing consumer to deposit the basic residence fee into a deposit account designated by the utilization housing supplier at the same time as signing a housing utilization contract is included.

And it is possible to include a provision stating that a deposit and withdrawal account designated by the utilization housing supplier for deposit of a basic residence fee and an additional residence fee is opened and registered to the housing utilization platform and a provision requiring the utilization housing consumer to deposit a basic residence fee to a designated deposit and withdrawal account of the utilization housing supplier at the same time as the conclusion of the housing utilization contract.

And it is possible to include a provision stating that a designated deposit and withdrawal account of the utilization housing supplier for deposit of a basic residence fee and an additional residence fee is opened and registered to the housing utilization platform and a provision stating that a deposit and withdrawal account designated by each utilization housing consumer is registered in the housing utilization platform to allow deposit of the utilization housing supplier to refund the remaining residence fee to each of multiple utilization housing consumers and withdrawal of the deposited remaining residence fee of each utilization housing consumer at the same time.

Accordingly, it is possible to deposit a basic residence fee and an additional residence fee, thereby allowing each of the multiple housing consumers to reside in the utilized house by applying for the allocation of the utilized house and applying for the exchange of the utilized house.

In addition, the contract includes a provision that the result of application is notified to the utilization housing consumer and disclosed in the housing utilization platform.

Therefore, as a result of the application for the allocation of the utilized house and the application for the exchange of the utilized house, it is possible to reside in a variety of environments and to move freely.

In addition, the contract includes a mandatory provision requiring the utilization housing consumer to deposit an additional residence fee before occupancy to reside in the utilized house when the standard market price of the utilized house in which the utilization housing consumer wishes to reside exceeds the value of the remaining residence fee of the utilization housing consumer, and a provision stating that when the remaining residence fee of the utilization housing consumer who wishes to reside exceeds the standard market price of the utilized house in which the consumer wishes to reside, a part of remaining residence fee is immediately refunded for the difference between the remaining residence fee of the utilization housing fee of the utilization housing consumer and the standard market price of the utilized house to a deposit and withdrawal account designated by the utilization housing consumer who is living in the utilized house through the refund application in the housing utilization platform after moving in.

And, as the condition of full refund of the remaining residence fee, the contract includes a provision stating that the remaining residence fee of each utilization housing consumer may be refunded by the utilization housing supplier depositing money to a deposit and withdrawal account designated by the utilization housing consumer when the utilization housing consumer vacates the utilized house where the utilization housing consumer resides and then applies for refund in the housing utilization platform.

In addition, it is possible to include a provision setting a housing utilization ending time which means the point at which it is impossible to reside in a utilized house anymore because all the residential value of the utilized house is lost by depreciation, while the housing utilization ending time is adjustable by the utilization housing supplier, and a provision allowing residence in a house after the housing utilization ending time at the same amount as the final remaining residence fee, while all problems arising from housing, such as house maintenance and repairs, are the responsibility of the utilization housing consumer.

And, in respect of the management of the utilized house, it is possible to include a provision in which the primary responsibility for the management of the utilized house (3), except for the negligence of a resident, is placed upon the utilization housing supplier.

And, at the step of residing and moving (S400), as a method for residing in the utilized house, it is possible to use both methods of allowing residence by initial allocation and by allocation for relocation from the utilized house where the consumer is residing, after the deposit of a basic residence fee to a designated deposit account of the housing utilization platform opened by the utilization housing supplier is completed at the same time as the conclusion of the housing utilization contract with the utilization housing supplier, while a method of allocation, competition and exchange may be used as a method for allocating the utilized house for residence.

Here, in a method of allocation and competition, after each of multiple utilization housing consumers selects an utilized house where the consumer wishes to reside through membership registration on the established housing utilization platform and browsing of various utilized houses that are disclosed for residence, designates a selected utilized house in the established housing utilization platform, and applies for allocation, the applied utilization housing consumer is selected if there is no competing utilization housing consumer, and the result is immediately notified to the utilization housing consumer and disclosed on the housing utilization platform at the same time, allowing immediate occupancy and residence. However, if there are competing utilization housing consumers, selection is made through a rotary method, and the selection is notified to all the utilization housing consumers who applied for allocation and disclosed in the housing utilization platform.

And, in an exchange method, the utilization housing consumer who wishes to move discloses the details of the utilized house in which the consumer resides, such as the location, area, and standard market price, in a designated part inside the housing utilization platform, and provides conditions of a utilized house where the consumer wishes to move, such as the location, area, and standard market price. When a utilization housing consumer (who wishes to move into the utilized house), who has read and confirmed the utilized house and conditions disclosed in relation to the exchange in the designated part of the housing utilization platform, immediately requests for an exchange, exchange occupancy by agreement is possible after confirming each other on-site with the consent of the utilization housing consumers who wish to relocate.

And, in the step of canceling the residence in the utilized house and refunding a remaining residence fee (S500), if an amount of remaining residence fee of the utilization housing consumer who wishes relocation exceeds the standard market price of the utilized house where the utilization housing consumer wishes to reside, the utilization housing consumer applies for refund of remaining residence amount on the housing utilization platform for the difference between the remaining residence fee of the utilization housing consumer and the standard market price of the utilized house, and refund of some remaining residence fee amounting to the difference is completed by the utilization housing supplier depositing the money to an opened deposit and withdrawal account designated by the utilization housing consumer.

In addition, after the utilization housing consumer who resides in the utilized house cancels the residence in the utilized house, the utilization housing consumer applies for refund of remaining residence fee on the housing utilization platform, and the refund of the total remaining residence fee is completed by the utilization housing supplier depositing the money to an opened deposit and withdrawal account designated by the utilization housing consumer.

And, a housing utilization ending time, which means the point at which it is impossible to reside in a utilized house anymore because all the residential value of the utilized house is lost by depreciation, is set, while its usefulness may be provided by allowing continuous residence in the utilized house even when the housing utilization ending time ends at the ends of house lifespan at the same amount as the final remaining residence fee, thereby being helpful for the economic life of the common people.

As described above, a method for the public utilization of housing according to the present invention enables free housing in desired location and environment at a reasonable price, quick housing relocation, and easy and convenient refund of housing funds. Accordingly, if a plurality of utilization housing complexes is built and operated in each country in the world, the anxiety about residing, which is the most important and difficult problem in other countries, will be fundamentally resolved, which may be greatly help to revitalize international exchanges, and even in Korea, exchanges with the metropolitan area, which have good educational and cultural environment and local regions with good natural environment will be greatly improved, thereby improving health and relaxation of people in the metropolitan area and providing economic help to local people.

And, if the state or local government utilizes the present invention, it is possible to prevent false assumptions in housing prices, to fundamentally block housing speculation, and to provide the utility of making it easier to manage other economic sectors with problems in the housing sector.

The present invention should not be construed as being limited to the embodiments set forth herein and may be embodied in many different forms within the scope of the present invention and those forms are included in the present invention.

1.-7. (canceled)

8. A method for the public utilization of housing, comprising the steps of:
establishing a housing utilization platform (40), wherein a housing utilization platform (4) operated and managed by a utilization housing supplier (1) is established;
disclosing and browsing utilized houses (41), allowing the utilization housing supplier (1) to disclose the utilized house (3) in the established housing utilization platform (4) and the utilization housing consumer (2) who signed up for membership to browse the disclosed utilized houses (3);
signing a housing utilization contract (50), wherein a housing utilization contract (5) is concluded between the utilization housing supplier (1) and multiple utilization housing consumers (2) based on results of browsing the utilized houses (3);
residing in and moving to utilized houses (60), wherein each of the multiple utilization housing consumers (2) resides in and moves to each utilized house (3) by depositing a basic residence fee (6) and an additional residence fee (7) based on the contents of the concluded housing utilization contract (5); and
canceling a residential contract of a utilized house and refunding a remaining residence fee (61), wherein the utilization housing supplier (1) returns a remaining residence fee (8) accrued when the utilization housing consumer (2) has lived in or moved to the respective utilized house (3) to each of multiple utilization housing consumer (2) who has lived in and moved to the utilized house (3).

9. The method for the public utilization of housing of claim 8, wherein a utilized house (3) is a house supplied by a new house supply method based on a right to utilize a house that has a value comparable to an ownership of the house, rather than based on the ownership of the house, allowing easy relocation, removing concerns about housing management, allowing immediate refund of residence fee, and allowing continuous residence in the utilized house (3) even after housing utilization ending time (90) to help economic life of common people, thereby solving shortcomings of housing residence and relocation using sale and rental based on ownership currently in general use.

10. The method for the public utilization of housing of claim 8, wherein a basic residence fee (6) means, in respect of residence in a utilized house (3), a basic residence amount that must be paid for residing in the utilized house (3) of same area,
which is set by a utilization housing supplier (1) considering an average standard market price (10) of new homes with the same area constructed all over the country regardless of location and environment, while multiple amounts may be set for each area,
cumulatively depreciated every day, as each of the multiple utilization housing consumers (2) resides in the respective utilized house (3), in the same amount as the standard market price (10) of each utilized house (3), and
when the utilization housing consumer (2) applies refund of a remaining residence fee (8) left after subtraction by residence from the basic residence fee (6) paid in the housing utilization platform (4) after canceling the residence in the utilized house (3) where the consumer is residing, the remaining residence fee (8) is immediately deposited by the utilization housing supplier (1) to a deposit and withdrawal account (80) designated by the utilization housing consumer (2) who applied refund of the remaining residence fee (8), registered in the housing utilization platform (4), thereby allowing withdrawal whenever it is needed, and then the details of deposit and refund is notified to the utilization housing consumer (2), and is simultaneously disclosed in the housing utilization platform (4).

11. The method for the public utilization of housing of claim 8, wherein an additional residence fee (7) is,
when the standard market price (10) of the utilized house (3) exceeds the value of the remaining residence fee (8),
accrued from a gap between the standard market price (10) of the utilized house (3) in which the utilization housing consumer wishes to reside and the remaining residence fee (8) of the utilization housing consumer (2) applied to the desired utilized house (3), and
an amount that needs to be deposited by the utilization housing consumer (2) who wishes to reside by adding a deficit to a deposit account (70) designated by the utilization housing supplier (1), opened in the housing utilization platform (4) to be the same amount as the standard market price (10) of the utilized house (3),
in which the detail of deposit is notified to the utilization housing consumer (2) who wishes to reside and is disclosed in the housing utilization platform (4).

12. The method for the public utilization of housing of claim 8, wherein a remaining residence fee (8) simultaneously means,
a balance of the same day of the basic residence fee (6) left after accumulating depreciation on a daily basis by the residence of the utilized house (3) from the basic residence fee (6) paid at the beginning of residence in the utilized house (3), and a balance of the same day left after accumulating depreciation on a daily basis for the residence period of the utilized house (3) after moving in, from the sum of remaining residence fee (8) which is a balance of the same day of the basic residence fee (6) and the additional residence fee (7) for moving in, and
in respect to relocation to the utilized house (3), if an amount of remaining residence fee (2) of the utilization housing consumer (2) who wishes to move to the utilized house exceeds the standard market price (10) of the desired utilized house (3),
for the difference between the remaining residence fee (2) of the utilization housing consumer (2) and the standard market price (10) of the desired utilized house (3)
the utilization housing consumer (2) who wishes to relocate applies for refund of the remaining residence fee (8) in the housing utilization platform (4), and refund of some remaining residence fee (8) amounting to the difference is completed by the utilization housing supplier (1) depositing the money to a deposit and withdrawal account (80) designated by the utilization housing consumer (2), who wishes to move in, registered in the housing utilization platform (4), and also
after the utilization housing consumer (2) cancels the residence in the utilized house (3) where the consumer resides,
the utilization housing consumer (2) who canceled the residence applies for refund of remaining residence fee (8) in the housing utilization platform (4), and
the refund of total applied amount of remaining residence fee (8) is completed by the utilization housing supplier (1) depositing the money to a deposit and withdrawal account (80) designated by the utilization housing consumer (2), who canceled the residential contract, registered in the housing utilization platform (4),
the detail of refund of the remaining residence fee (8) is notified to the utilization housing consumer (2) who receives the refund, and
is disclosed in the housing utilization platform (4).

13. The method for the public utilization of housing of claim 8, allowing, in an established housing utilization platform (4), all matters comprising:
membership registration of a utilization housing consumer (2);
disclosure of habitable utilized house (3) by a utilization housing supplier (1);
disclosure of utilized house (3) to be moved by the utilization housing supplier (1);
disclosure of utilized house (3) applied for movement by the utilization housing consumer (2);
browser of utilized house (3) for residential use by the utilization housing consumer (2);
disclosure of the standard market price (10) of utilized house (3) by the utilization housing supplier (1);
confirmation of the standard market price (10) of utilized house (3) by the utilization housing consumer (2);
conclusion of a housing utilization contract (5) between the utilization housing supplier (1) and the utilization housing consumer (2);
open and registration of a designated deposit account (70) by the utilization housing supplier (1);
registration of each designated deposit and withdrawal account (80) for each of the utilization housing consumers (2);
payment of basic residence fee (6) by the utilization housing consumer (2);
notification of the basic residence fee (6) payment details by the utilization housing supplier (1);
disclosure of the payment result of basic residence fee (6) by the utilization housing supplier (1);
application for allocation of utilized house (3) by the utilization housing consumer (2);
disclosure of allocation application results of utilized house (3) by utilization housing consumers (2);
application for exchange of utilized houses (3) by the utilization housing consumer (2);
disclosure of exchange application results of the utilized house (3) by the utilization housing suppliers (1);
payment of additional residence fee (7) by the utilization housing consumer (2);
notification of additional residence fee (7) payment details by the utilization housing supplier (1);
disclosure of additional residence fee (7) payment results by the utilization housing supplier (1);
disclosure of remaining residence fee (8) by the utilization housing supplier (1);
confirmation of remaining residence fee (8) by the utilization housing consumer (2);
application for refund of remaining residence fee (8) by the utilization housing consumer (2);
refund of remaining residence fee (8) by the utilization housing supplier (1);
notification of refund results of remaining residence fee (8) by the utilization housing supplier (1);
disclosure of refund results of remaining residence fee (8) by the utilization housing supplier (1);
application for defect repair by the utilization housing consumer (2); and
disclosure of defect repair results by the utilization housing supplier (1).

14. The method for the public utilization of housing of claim 8, wherein, at the step of disclosing and browsing utilized houses (41), the standard market price (10) is needed to be evaluated for disclosure of the utilized house (3) by an evaluation method, in which:
\textcircled{1} Standard market price of utilized house=amount per m²×area of the building to be evaluated (m²)
\textcircled{2} Amount per m²=standard amount of new building price×structural index×location index×residual value rate per elapsed year are applied,
wherein the structural index is applied by dividing into 10 levels according to the degree of convenience; and
the location index is applied by dividing into 20 levels from large cities to rural areas.
The depreciation rate by elapsed years is applied as
1 year (new construction): 100%,
1 to 10 years: 35%,
10 to 20 years: 25%,
20 to 30 years: 20%,
30 to 40 years: 10%,
and 40 to 50 years: 10%, and
the detailed residual portion rate and depreciation rate are applied as
1 to 10 years
1 to 2 years: 96% (depreciation rate of 4%), 2 to 3 years: 92% (depreciation rate of 4%), 3 to 4 years: 88% (depreciation rate of 4%), 4 to 5 years: 82% (depreciation rate of 4%), 5 to 6 years: 78% (depreciation rate of 4%), 6 to 7 years: 74% (depreciation rate of 4%), 7 to 8 years: 71% (depreciation rate of 3%), 8 to 9 years: 68% (depreciation rate of 3%), and 9 to 10 years: 65% (depreciation rate of 3%),
10 to 20 years
10 to 11 years: 62% (depreciation rate of 3%), 11 to 12 years: 59% (depreciation rate of 3%), 12 to 13 years: 56% (depreciation rate of 3%), 13 to 14 years: 53% (depreciation rate of 3%), 14 to 15 years: 50% (depreciation rate of 3%), 15 to 16 years: 48% (depreciation rate of 2%), 2016 to 17: 46% (depreciation rate of 2%), 17 to 18 years: 44% (depreciation rate of 2%), 18 to 19 years: 42% (depreciation rate of 2%), and 19 to 20 years: 40% (depreciation rate of 2%),
20 to 30 years: 40% (annual depreciation rate of 1.5%),
30 to 50 years
30 to 35 years: 25% (annual depreciation rate of 1.5%),
36 to 50 years: 25% (annual depreciation rate of 1%),
but the depreciation rate and residual value rate set from 1 to 50 years are adjusted by the utilization housing supplier (1).
In addition, as the standard market price (10) evaluation criteria for the utilized house (3) at the time of purchase,
\textcircled{1} Standard market price of utilized house=amount per m²×area of the building to be evaluated (m²)
\textcircled{2} Amount per m²=standard amount of new building price×structural index×location index×residual portion rate per elapsed year are applied in the same manner as the evaluation criteria of a new utilized house (3),
wherein the structural index is applied by dividing into 10 levels according to the degree of convenience; and
the location index is applied by dividing into 20 levels from large cities to rural areas according to the official land price and housing convenience, and
the individual housing deterioration degree of the utilized house (3) is added in 10 levels and reflected,
but it is set by the utilization housing supplier (1).

15. The method for the public utilization of housing of claim 8, wherein,
at the step of signing a housing utilization contract (50),
the concluded contents of the housing utilization contract include:
basic provisions of the contract, which are necessary for using the housing utilization platform (10), such as information on the contracting parties, contract date and time, and the signatures of the contracting parties;
a provision requiring the utilization housing consumer (2) who wishes to reside in the utilized house (3) to deposit the basic residence fee (6) into a deposit account (70) designated by the utilization housing supplier (1) at the same time as signing the housing utilization contract (5); and
a provision requiring the utilization housing consumer (2) who wishes to reside in the utilized house (3) to deposit additional residence fee (7) before occupancy when moving in,
if the standard market price (10) of the utilized house (3) desired to reside exceeds the amount of remaining residence fee (8) of the housing utilization consumer (2) who wishes to reside.
